(19) United States
(12) Patent Application Publication
(10) Pub. No.: US 2026/0269160 A1
(43) Pub. Date: Sep. 10, 2026

(54) SYSTEMS AND METHODS FOR VERIFYING PROTECTIVE RELAY OUTPUT CONTACT OPERATION

(71) Applicant: Schweitzer Engineering Laboratories, Inc., Pullman, WA (US)

(72) Inventors: Austin Edward Wade, Moscow, ID (US); Brandon Michael Nafsinger, Caldwell, ID (US); David Schmidt, Athens, GA (US); Jordan Bell, Pullman, WA (US)

(73) Assignee: Schweitzer Engineering Laboratories, Inc., Pullman, WA (US)

(21) Appl. No.: 19/072,076

(22) Filed: Mar. 6, 2025

(51) Int. Cl. H01H 47/00; H02H 1/00; H02H 7/22

(52) U.S. Cl. CPC H01H 47/002; H02H 1/0007; H02H 1/0092; H02H 7/222

(57) ABSTRACT

Systems, methods, and devices presented herein are directed toward verifying the operation of protective relays in an electric power delivery system. To protect components of the power delivery system, a protection system may be implemented. The protection system may include a relay containing an output contact, a voltage sensor coupled to the output contact, and a current sensor coupled to the output contact. The protection system may also include processing circuitry used to determine the operation of the output contact based on an indication from the voltage senor, the current sensor, or both.

### BACKGROUND

This disclosure relates to protection devices in an electric power delivery system. More particularly, this disclosure relates to verifying the operation of protective relays in the electric power delivery system.

Trip circuit monitoring (TCM) devices may be used to verify the operation of protective devices such as protective relays in the electric power delivery system. The TCM devices may self-test and notify a user that a component or system has failed. An output contact of the protective relay used to trip and close a breaker may have limited means to self-test. For example, if a protective relay calls for an output to be closed, the TCM devices may be unable to verify that the output and subsequently a circuit operated correctly, especially when multiple trip outputs are electrically coupled in parallel.

Generally, TCM devices use a protection scheme with a standard binary input in parallel with a relay trip output to verify the status of a trip circuit. When the standard binary input is deasserted for longer than a set amount of time and a breaker is closed, this may signal to the user that there is a problem with the trip circuit that should be investigated. The TCM method described above may be able to detect problems with the circuit but may be limited in functionality. Specifically, the TCM method may be primarily used for detecting open-circuit conditions in the trip circuit. The TCM method may be unable to detect a failure of the relay output contact, a short-circuited trip coil, and/or abnormal operation of the breaker.

### BRIEF DESCRIPTION OF THE DRAWINGS

FIG. 1 is a schematic diagram of an embodiment of an electric power delivery system, in accordance with an embodiment of the present disclosure;

FIG. 2 is a schematic diagram of an embodiment of a computing system that may be incorporated in a component of the electric power delivery system, in accordance with an embodiment of the present disclosure;

FIG. 3 is a schematic diagram of a trip circuit system with a trip circuit monitoring (TCM) scheme, in accordance with an embodiment of the present disclosure;

FIG. 4 is a schematic diagram of a trip circuit system with a first trip circuit, a second trip circuit, and a cross-tripping scheme, in accordance with an embodiment of the present disclosure;

FIG. 5 is a schematic diagram of a trip circuit system with a relay contact monitoring scheme, in accordance with an embodiment of the present disclosure;

FIG. 6 is a graph illustrating a current profile for a trip coil;

FIG. 7 is a flowchart of an example method for verifying the operation of an output contact of a protective relay, in accordance with an embodiment of the present disclosure;

FIG. 8 is a voltage graph and a current graph of a trip window of a relay A and a relay B and a corresponding schematic diagram of the trip circuit of FIG. 5, in accordance with an embodiment of the present disclosure;

FIG. 9 is a voltage graph and a current graph of a successful output of the relay A and a corresponding schematic diagram of the trip circuit of FIG. 5, in accordance with an embodiment of the present disclosure;

FIG. 10 is a voltage graph and a current graph of the successful output of the relay A and an unknown output of the relay B and a corresponding schematic diagram of the trip circuit of FIG. 5, in accordance with an embodiment of the present disclosure;

FIG. 11 is a voltage graph and a current graph of the trip window of the relay A and the relay B, the successful output of the relay A, and a failed output of the relay B and a corresponding schematic diagram of the trip circuit of FIG. 5, in accordance with an embodiment of the present disclosure; and

FIG. 12 is a voltage graph and a current graph of the trip window of the relay A and the relay B, the successful output of the relay A, and a no call of the relay B and a corresponding schematic diagram of the trip circuit of FIG. 5, in accordance with an embodiment of the present disclosure.

### DETAILED DESCRIPTION

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be noted that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase “A or B” is intended to mean A, B, or both A and B.

Breaker trip circuits may have a direct current (DC) supply, relay output contacts, a breaker trip coil (TC), and associated wiring. These breaker trip circuits may be called to operate in milliseconds after months or years of sitting idle. A failure or degradation of any one of these components may result in a failure to trip a circuit breaker during a system fault, thereby extending fault duration, increasing an outage zone (e.g., when backup protection clears the system fault), and potentially causing system instability, equipment damage, or the like. Because of the critical function of a trip circuit, trip circuit monitoring (TCM) schemes, also referred to as trip circuit supervision schemes, may be employed. TCM schemes may be implemented with a goal of detecting failures as early as possible and providing alarms to system operators.

Modern protection systems may employ redundancy for critical applications to ensure a protection scheme operates as intended. This may include redundant relays, multiple TCs, and separate DC supplies. In addition, microprocessor-based relays may provide ways for a relay and protection system to test themselves. Even with self-testing possible in modern protection and control systems, the monitoring and self-testing of relay output contacts are relegated to periodic function testing performed by maintenance personnel. The present disclosure describes a protective relay output contact that may allow the relay to record and measure voltage across the protective relay output contact and current flowing through the protective relay output contact. The protective relay output contact may implement an algorithm to enable the relay to verify a suitable operation of the relay output contact such as validating an output contact closure and discriminating an output contact failure from other problems in a DC circuit.

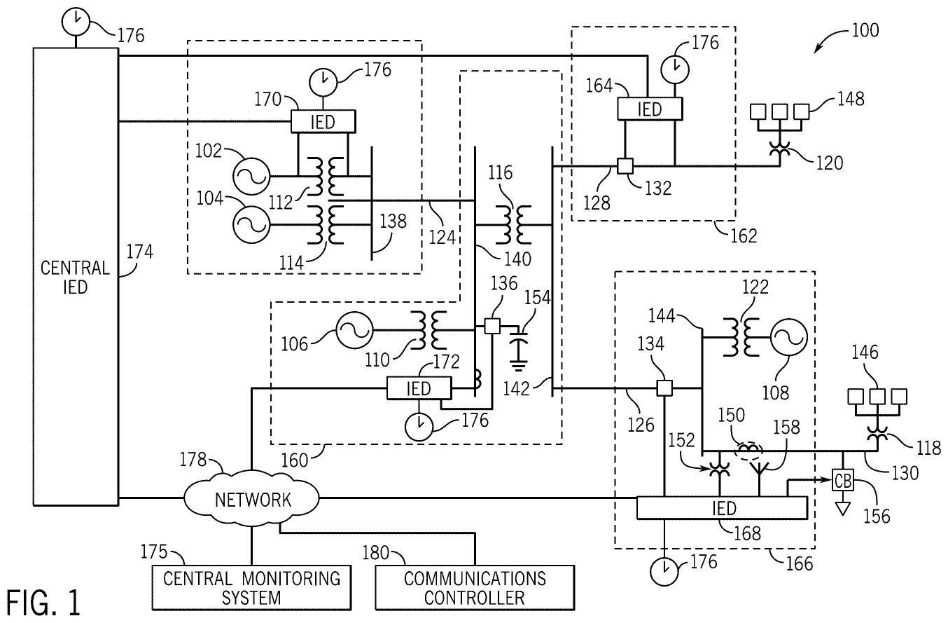

FIG. 1 illustrates a simplified diagram of an electric power delivery system 100, in accordance with an embodiment of the present disclosure. The electric power delivery system 100 may generate, transmit, and/or distribute electric energy to one or more loads. As illustrated, the electric power delivery system 100 includes electric generators 102, 104, 106, and 108. The electric power delivery system 100 may also include power transformers 110, 112, 114, 116, 118, 120, and 122. Furthermore, the electric power delivery system may include lines 124, 126, 128, and 130 to transmit and/or deliver power. Circuit breakers 132, 134, and 136 may be used to control flow of power in the electric power delivery system 100. Busses 138, 140, 142, and 144 and/or loads 146 and 148 receive the power in and/or from (e.g., output by) the electric power delivery system 100. A variety of other types of equipment may also be included in electric power delivery system 100, such as current sensors (e.g., wireless current sensor (WCS) 150), potential transformers (e.g., potential transformer 152), voltage regulators, capacitors (e.g., capacitor 154) and/or capacitor banks (e.g., capacitor bank (CB) 156), antennas (e.g., antenna 158), and other suitable types of equipment useful in power generation, transmission, and/or distribution.

A substation 160 may include the electric generator 106, which may be a distributed generator, and which may be connected to the bus 140 through the power transformer 110 (e.g., a step-up transformer). The bus 140 may be connected to a distribution bus 142 via the power transformer 116 (e.g., a step-down transformer). Various distribution lines 126 and 128 may be connected to the distribution bus 142. The distribution line 128 may be connected to a substation 162 where the distribution line 128 is monitored and/or controlled using an intelligent electronic device (IED) 164, which may selectively open and close the circuit breaker 132. A load 148 may be fed from the distribution line 128. The power transformer 120 (e.g., a step-down transformer), in communication with the distribution bus 142 via distribution line 128, may be used to step down a voltage for consumption by the load 148.

A distribution line 126 may deliver electric power to a bus 144 of a substation 166. The bus 144 may also receive electric power from a distributed generator 108 via transformer 122. The distribution line 130 may deliver electric power from the bus 144 to a load 146, and may include the power transformer 118 (e.g., a step-down transformer). A circuit breaker 134 may be used to selectively connect the bus 144 to the distribution line 126. The IED 168 may be used to monitor and/or control the circuit breaker 134 as well as the distribution line 130.

The electric power delivery system 100 may be monitored, controlled, automated, and/or protected using IEDs such as the IEDs 164, 168, 170, 172, and 174, and a central monitoring system 175. In general, the IEDs in an electric power generation and transmission system may be used for protection, control, automation, and/or monitoring of equipment in the system. For example, the IEDs may be used to monitor equipment of many types, including electric transmission lines, electric distribution lines, current sensors, busses, switches, circuit breakers, reclosers, transformers, autotransformers, tap changers, voltage regulators, capacitor banks, generators, motors, pumps, compressors, valves, and a variety of other suitable types of monitored equipment.

As used herein, an IED (e.g., the IEDs 164, 168, 170, 172, and 174) may refer to any processing-based device that monitors, controls, automates, and/or protects monitored equipment within the electric power delivery system 100. Such devices may include, for example, remote terminal units, merging units, differential relays, distance relays, directional relays, feeder relays, overcurrent relays, voltage regulator controls, voltage relays, breaker failure relays, generator relays, motor relays, automation controllers, bay controllers, meters, recloser controls, communications processors, computing platforms, programmable logic controllers (PLCs), programmable automation controllers, input and output modules, and the like. The term IED may be used to describe an individual IED or a system including multiple IEDs. Moreover, an IED of this disclosure may use a non-transitory computer-readable medium (e.g., memory) that may store instructions that, when executed by a processor of the IED, cause the processor to perform processes or methods disclosed herein. Moreover, the IED may include a wireless communication system to receive and/or transmit wireless messages from a wireless electrical measurement device. The wireless communication system of the IED may be able to communicate with a wireless communication system of the wireless electrical measurement devices, and may include any suitable communication circuitry for communication via a personal area network (PAN), such as Bluetooth or ZigBee, a local area network (LAN) or wireless local area network (WLAN), such as an 368.11x Wi-Fi network, and/or a wide area network (WAN), (e.g., third-generation (3G) cellular, fourth-generation (4G) cellular, universal mobile telecommunication system (UMTS), long term evolution (LTE), long term evolution license assisted access (LTE-LAA), fifth-generation (5G) cellular, and/or 5G New Radio (5G NR) cellular). In some cases, the IEDs may be located remote from the respective substation and provide data to the respective substation via long-distance communication (e.g., radio, a fiber-optic cable, a communications network).

A common time signal may be distributed throughout the electric power delivery system 100. Utilizing a common time source 176 may ensure that IEDs have a synchronized time signal that can be used to generate time synchronized data, such as synchrophasors. In various embodiments, the IEDs 164, 168, 170, 172, and 174 may be coupled to a common time source(s) 176 and receive a common time signal. The common time signal may be distributed in the electric power delivery system 100 using a communications network 178 and/or using a common time source 176, such as a Global Navigation Satellite System (“GNSS”), or the like.

According to various embodiments, the central monitoring system 175 may include one or more of a variety of types of systems. For example, the central monitoring system 175 may include a supervisory control and data acquisition (SCADA) system and/or a wide area control and situational awareness (WACSA) system. A central IED 174 may be in communication with the IEDs 164, 168, 170, and 172. The IEDs 164, 168, 170, and 172 may be located remote from the central IED 174, and may communicate over various media such as a direct communication from IED 164 or over the communications network 178. According to various embodiments, some IEDs may be in direct communication with other IEDs. For example, the IED 170 may be in direct communication with the central IED 174. Additionally or alternatively, some IEDs may be in communication via the communications network 178. For example, the IED 168 may be in communication with the central IED 174 via the communications network 178. In some embodiments, an IED may refer to a relay, a merging unit, or the like.

Communication via the communications network 178 may be facilitated by networking devices including, but not limited to, multiplexers, routers, hubs, gateways, firewalls, and/or switches. In some embodiments, the IEDs and the network devices may include physically distinct devices. In certain embodiments, the IEDs and/or the network devices may be composite devices that may be configured in a variety of ways to perform overlapping functions. The IEDs and the network devices may include multi-function hardware (e.g., processors, computer-readable storage media, communications interfaces, etc.) that may be utilized to perform a variety of tasks that pertain to network communications and/or to operation of equipment within the electric power delivery system 100.

A communications controller 180 may interface with equipment in the communications network 178 to create a software-defined network (SDN) that facilitates communication between the IEDs 164, 168, 170, 172, and 174 and the central monitoring system 176. In various embodiments, the communications controller 180 may interface with a control plane (not shown) in the communications network 178. Using the control plane, the communications controller 180 may direct the flow of data within the communications network 178.

The communications controller 180 may receive information from multiple devices in the communications network 178 regarding transmission of data. In embodiments in which the communications network 178 includes fiber optic communication links, the data collected by the communications controller 180 may include reflection characteristics, attenuation characteristics, signal-to-noise ratio characteristics, harmonic characteristics, packet loss statics, and the like. In embodiments in which the communications network 178 includes electrical communication links, the data collected by the communications controller 180 may include voltage measurements, signal-to-noise ratio characteristics, packet loss statics, and the like. In some embodiments, the communications network 178 may include both electrical and optical transmission media. The information collected by the communications controller 180 may be used to assess a likelihood of a failure, to generate information about precursors to a failure, and to identify a root cause of a failure. The communications controller 180 may associate information regarding a status of various communication devices and communication links to assess a likelihood of a failure. Such associations may be utilized to generate information about the precursors to a failure and/or to identify root cause(s) of a failure consistent with embodiments of the present disclosure.

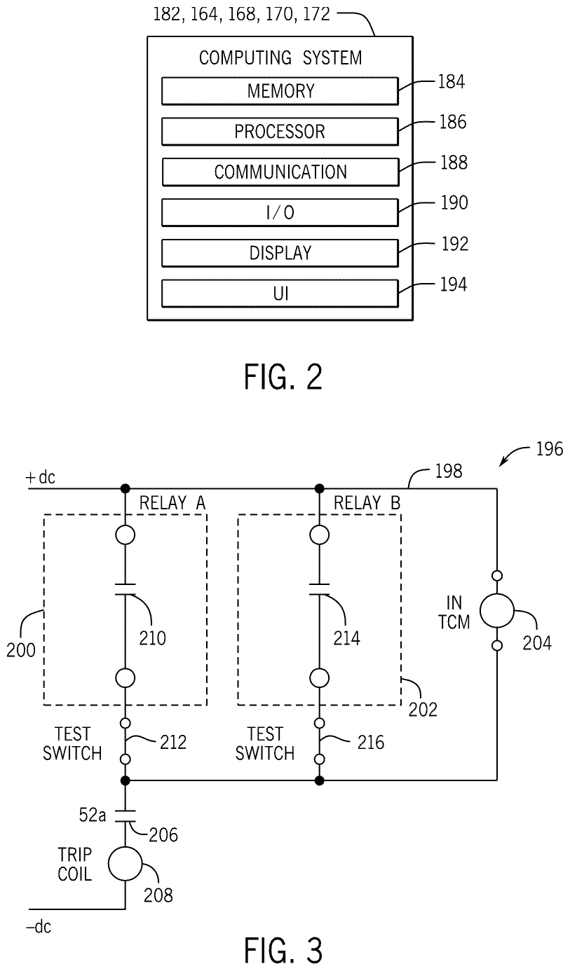

FIG. 2 is a schematic diagram of an embodiment of a computing system 182 that may be incorporated within a component of the electric power delivery system 100, such as in any of the IEDs 164, 168, 170, and/or 172. The computing system 182 may include a memory 184 and a processor or processing circuitry 186. The memory 184 may include a non-transitory computer-readable medium that may store instructions that, when executed by the processor 186, may cause the processor 186 to perform various methods described herein. To this end, the processor 186 may be any suitable type of computer processor or microprocessor capable of executing computer-executable code, including but not limited to one or more field programmable gate arrays (FPGA), application-specific integrated circuits (ASIC), programmable logic devices (PLD), programmable logic arrays (PLA), and the like. The processor 186 may, in some embodiments, include multiple processors.

The computing system 182 may also include a communication system 188, which may include a wireless and/or wired communication component to establish a communication link with another component of the electric power delivery system 100. That is, the communication system 188 enables the computing system 182 (e.g., of one of the IEDs 164, 168, 170, 172) to communicate with another communication system 188 of another computing system 182, such as via MACsec. Indeed, the communication system 188 may include any suitable communication circuitry for communication via a personal area network (PAN), such as Bluetooth or ZigBee, a local area network (LAN) or wireless local area network (WLAN), such as an 368.11x Wi-Fi network, and/or a wide area network (WAN), (e.g., third-generation (3G) cellular, fourth-generation (4G) cellular, near-field communications technology, universal mobile telecommunication system (UMTS), long term evolution (LTE), long term evolution license assisted access (LTE-LAA), fifth-generation (5G) cellular, and/or 5G New Radio (5G NR) cellular). The communication system 188 may also include a network interface to enable communication via various protocols such as EtherNet/IP®, ControlNet®, DeviceNet®, or any other industrial communication network protocol.

Additionally, the computing system 182 may include input/output (I/O) ports 190 that may be used for communicatively coupling the computing system 182 to an external device. For example, the I/O ports 190 of the computing system 182 may communicatively couple to corresponding I/O ports 190 of the computing system 182. The computing system 182 may further include a display 192 that may present any suitable image data or visualization. Indeed, the display 192 may present image data that includes various information regarding the electric power delivery system 100, thereby enabling the user to observe an operation, a status, a parameter, other suitable information, or any combination thereof, of the electric power delivery system 100. Further still, the computing system 182 may include a user interface (UI) 194 with which the user may interact to control an operation of the computing system 182. For instance, the UI 194 may include a touch screen (e.g., as a part of the display 192), an eye-tracking sensor, a gesture (e.g., hand) tracking sensor, a joystick or physical controller, a button, a knob, a switch, a dial, a trackpad, a mouse, another component, or any combination thereof.

FIG. 3 is a schematic diagram of a trip circuit system 196 with a traditional trip circuit monitoring (TCM) scheme. The trip circuit system 196 may include a trip circuit 198 with a direct current (DC) power supply, two relays (e.g., a first relay A 200 and a second relay B 202), and a trip circuit monitor 204 electrically coupled to a 52a contact 206 and a trip coil (TC) 208. The first relay A 200 may include a first output contact 210. A first test switch 212 may be coupled between the first relay A 200 and the 52a contact 206. The second relay B 202 may include a second output contact 214. A second test switch 216 may be coupled between the second relay B 202 and the 52a contact 206.

Protection systems may be designed with fault tolerance in mind, enabling them to fulfill their intended function even in the event of a single-component failure, often referred to as N-1 tolerance. To this end, some protection systems such as the trip circuit 198 may include redundant componentry, such as the first relay A 200 and the second relay B 202. Failures may be broadly classified as detectable and undetectable. Detectable failures may self-announce or alert operators to a troubled or malfunctioning component through automated self-testing or system-wide monitoring. However, undetectable failures may remain undetected until manually identified and rectified; these are also known as “hidden” failures.

With the above in mind, the binary input of the TCM circuitry 204, disposed in parallel to the first relay A 200 and the second relay B 202, may determine the presence of voltage across the first output contact 210 and the second output contact 214. The presence or absence of voltage may be compared to the status of the trip circuit system 196 obtained from other methods to determine the status of trip coil 208 or the direct current power supply. For example, with the first output contact 210 open, the second output contact 214 open, and the circuit breaker associated with trip coil 208 closed, an absence of voltage detected by the binary input of the TCM circuitry 204 indicates a failure of trip coil 208, 52a contact 206, the direct current power supply, or the wiring between these components. The aforementioned example represents a failure mode which is detectable by a traditional trip circuit monitoring scheme.

However, if, for example, the first relay A 200 is not functioning properly but the second relay B 202 is functioning properly, when a trip is indicated, the first output contact 210 will not close and no current will flow through the first relay A 200, but the second output contact 214 will close and current will flow through the second relay B 202. The current through the second output contact 214 will energize the trip coil 208 and open the associated breaker. The aforementioned example represents a failure mode which is not detectable by a traditional trip circuit monitoring scheme. The TCM circuitry 204 will not detect and will not indicate any issue with the first relay A 200. Consequently, there may be no indication that the first relay A 200 is not operational, and thus the first relay A 200 may remain non-operational for weeks, months, or years at a time. This may result in undesirable ramifications for the electric power delivery system 100 if the second relay B 202 experiences issues and becomes non-operational as well. Furthermore, if a failure such as the one described above remains undetected by system self-testing or monitoring, it may have potential to evolve into an N-1-1 failure.

Another example of a system design that may create an undetectable hidden failure occurs when redundant relays cross-trip multiple trip coils. Circuit breakers may employ multiple trip coils to enhance reliability. For example, a common practice is to energize both trip coils simultaneously during each trip event or activate a secondary trip coil after a brief delay to ensure that the breaker still trips promptly, even if one trip coil fails.

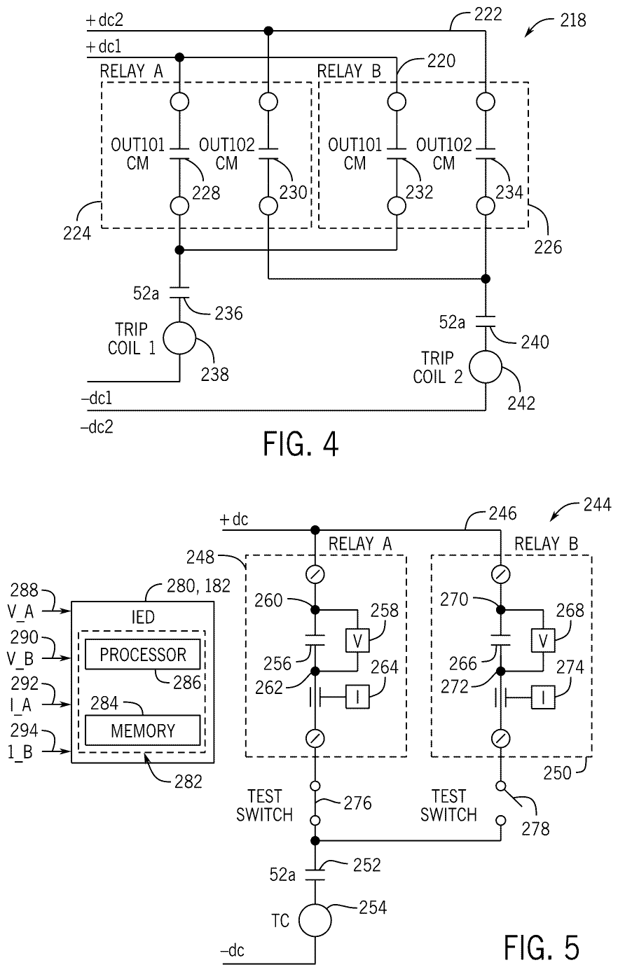

Considering the above, FIG. 4 is a schematic diagram of a trip circuit system 218 with a first trip circuit 220, a second trip circuit 222, and a cross-tripping scheme. The cross-tripping scheme may include two relays (e.g., a first relay A 224 and a second relay B 226). The first relay A 224 may include a first output contact 228 and a second output contact 230, and the second relay B 226 may include a third output contact 232 and a fourth output contact 234. The first trip circuit 220 may be a DC circuit and may include the first output contact 228 of the first relay A and the third output contact 232 of the second relay B electrically coupled to a first 52a contact 236 and a first trip coil (TC1) 238. The second trip circuit 222 may also be a DC circuit and may include the second output contact 230 of the first relay A and the fourth output contact 234 of the second relay B electrically coupled to a second 52a contact 240 and a second trip coil (TC2) 242.

In the cross-tripping scheme described above, the first relay A 224 and the second relay B 226 may energize both the TC1 238 and the TC2 242. As long as at least one path (e.g., at least one of the first trip circuit 220 and the second trip circuit 222) works, no failure may be determined or detected. For example, if the first relay A 224 is not functioning properly and the second relay B 226 is functioning properly, the trip circuit system 218 may successfully trip without the first relay A 224, then the failure of the first relay A may remain unnoticed as a hidden failure for long periods of time.

For instance, if the first relay A 224 and the second relay B 226 both trip the TC1 238 and the TC2 242 and the breaker opens, there may be no indication that all components in each trip circuit operated correctly, only that a combination of the trip circuits resulted in the breaker tripping. Alternatively, if the first relay A 224 and the second relay B 226 both assert an operating logic for the first output contact 228 of the first relay A 224 and the third output contact 232 of the second relay B 226 at the same time or near the same time, it may be difficult to determine if each output contact operated correctly. Therefore, it may be difficult to find these failures except through less desirable methods or circumstances such as event report inspection, through manual testing, or when another cascading failure occurs. As will be discussed in greater detail below, to address the issues described in the preceding discussion, each relay may include a voltage sensor coupled across each output contact that may be within a housing of the relay and include a current sensor disposed at the output of each output contact that may be within the housing of the relay. This may enable systems with redundant relays and/or redundant output contacts to determine that one or more output contacts or other trip circuit components are non-functional or in an abnormal state even in instances where a breaker successfully trips.

With the foregoing in mind, FIG. 5 is a schematic diagram of a trip circuit system 244 (e.g., a protection system) with a trip circuit 246 and a relay contact monitoring scheme. The trip circuit 246 may be a DC circuit and may include two relays (e.g., a first relay A 248 and a second relay B 250) electrically coupled to a 52a contact 252 and a trip coil (TC) 254. The first relay A 248 may include a first output contact 256 (e.g., a comprehensive measuring contact), a first voltage measuring component 258 coupled to an input 260 of the first output contact 256 and coupled to an output 262 of the first output contact 256, and a first current measuring component 264 coupled to the output 262 of the first output contact 256. The second relay B 250 may include a second output contact 266 (e.g., a comprehensive measuring contact), a second voltage measuring component 268 coupled to an input 270 of the second output contact 266 and an output 272 of the second output contact 266, and a second current measuring component 274 coupled to the output 272 of the second output contact 266. A first test switch 276 may be coupled between the first relay A 248 and the 52a contact 252 and a second test switch 278 may be coupled between the second relay B 250 and the 52a contact 252.

The first voltage measuring component 258 may measure a first voltage across the first output contact 256 and the first current measuring component 264 may measure a first current through the first output contact 256. The first voltage measuring component 258 may include a voltage sensor that may be within the housing of the first relay A 248. The first current measuring component 264 may include a current sensor that may be within the housing of the first relay A 248. Additionally, the second voltage measuring component 268 may measure a second voltage across the second output contact 266 and the second current measuring component 274 may measure a second current through the second output contact 266. The second voltage measuring component 268 may include another voltage sensor that may be within the housing of the second relay B 250. The second current measuring component 274 may include another current sensor that may be within the housing of the second relay B 250.

The voltage sensor may provide a binary status by using standard voltage thresholds that mimic a binary input (e.g., a traditional binary input) coupled across a trip contact (e.g., the first output contact 256 and the second output contact 266). A relay may use these binary data for integrated TCM logic (e.g., integrated traditional TCM logic) and close coil monitoring (CCM) logic or breaker position indications. Voltage measuring components may have an operational range of 38 to 196 Volts (V) DC with a resolution of ±2 V DC.

The current sensor may be an anisotropic magneto resistance current sensor (e.g., the first current measuring component 264 and the second current measuring component 274) that may provide high accuracy over a wide range of DC current measurements, while also providing electrical isolation and an ability to reject common-mode magnetic fields, which can affect low-level measurements. Current measuring components may have an operational range of 0.25 to 20.0 Amps (A) (e.g., of DC current) with a resolution of ≤0.1 A. The first output contact 256 and the second output contact 266 may adhere to IEEE C 37.90 and provide up to a 30 A make capability. The measurement may be clipped above the operational range of 20 A. This may occur on oil circuit breakers in which individual trip coils (e.g., TC 254) for each pole may be wired and energized in parallel to three-pole trip.

Including integrated voltage and current measuring components (e.g., the first voltage measuring component 258, the second voltage measuring component 268, the first current measuring component 264, and the second current measuring component 274) in a protective relay (e.g., the first relay A 248 and the second relay B 250) in breaker control circuitry may increase an ability to detect failures in trip and close circuits.

An intelligent electronic device (IED) 280 may include a data processing system 282 that includes a memory 284 and a processor or processing circuitry 286. The computing system 182 of FIG. 2 may be incorporated within a component of the electric power delivery system 100, such as in the IED 280. The term IED may be used to describe an individual IED or a system including multiple IEDs. The memory 284 may include a non-transitory computer-readable medium that may store instructions that, when executed by the processor 286, may cause the processor 286 to perform various methods described herein. To this end, the processor 286 may be any suitable type of computer processor or microprocessor capable of executing computer-executable code, including but not limited to one or more field programmable gate arrays (FPGA), application-specific integrated circuits (ASIC), programmable logic devices (PLD), programmable logic arrays (PLA), and the like. The processor 286 may, in some embodiments, include multiple processors.

For example, in a distributed scheme, the first relay A 248 may be a first IED and the second relay B 250 may be a second IED. The voltage sensors (e.g., the first voltage measuring component 258 and the second voltage measuring component 268) and the current sensors (e.g., the first current measuring component 264 and the second current measuring component 274) may record information (e.g., measurement readings). Furthermore, the first IED of the first relay A 248 may measure voltage and current within the first relay A 248 and determine the operation of the first output contact 256, and the second IED of the second relay B 250 may measure voltage and current within the second relay B 250 and determine the operation of the second output contact 266. It should be noted that the first relay A 248 and the second relay B 250 may not communicate with each other.

In another example, in a centralized scheme, the IED 280 may be used to control the first relay A 248 and the second relay B 250. The voltage sensors (e.g., the first voltage measuring component 258 and the second voltage measuring component 268) and the current sensors (e.g., the first current measuring component 264 and the second current measuring component 274) may send information (e.g., measurement readings) to the IED 280. Furthermore, the IED 280 may read a first voltage measurement 288 (e.g., V_A) from the first voltage measuring component 258 of the first output contact 256 and a second voltage measurement 290 (e.g., V_B) from the second voltage measuring component 268 of the second output contact 266. The IED 280 may also read a first current measurement 292 (e.g., I_A) from the first current measuring component 264 of the first output contact 256 and a second current measurement 294 (e.g., I_B) from the second current measuring component 274 of the second output contact 266. It should be noted that the voltage measuring components and the current measuring components may be attached physically (e.g., by wiring) to the IED 280 or communicate through a wireless signal.

The processing circuitry 286 of the IED 280 may be able to determine the operation of the first output contact 256 based on indications received from the first voltage measuring component 258 and/or the first current measuring component 264. The processing circuitry 286 may also be able to determine the operation of the second output contact 266 based on indications received from the second voltage measuring component 268 and the second current measuring component 274. Furthermore, the processing circuitry 286 may give indications to close the first output contact 256 and/or the second output contact 266. For example, the first relay A 248 may receive an indication from the processing circuitry 286 to close the first output contact 256.

In addition, the processing circuitry 286 may be used to calculate a change in voltage based on the indications received from the first voltage measuring component 258 and the second voltage measuring component 268. The processing circuitry 286 may determine if the first voltage measurement 288 and/or the second voltage measurement 290 drops below a voltage threshold. The processing circuitry 286 may also be used to calculate a change in the first current measurement 292 and/or the second current measurement 294 based on the indications received as well as determining if the current increases above a first current threshold.

The processing circuitry 286 may calculate the change in voltage based on an indication received from the first voltage measuring component 258 after the first relay A 248 receives the indication to close the first output contact 256. The processing circuitry 286 may determine there was no change in voltage across the first output contact 256 after the first relay A 248 received the indication to close the first output contact 256. Furthermore, the second voltage measuring component 268 may calculate the change in voltage and send an indication to the processing circuitry 286 based on the second relay B 250 receiving the indication to close the second output contact 266. The processing circuitry 286 may, based on the indication received from the second voltage measuring component 268, determine there was no change in voltage after the second relay B 250 received the indication to close the second output contact 266.

The first voltage measurement 288 and the first current measurement 292 may enable the IED 280 to determine if the first output contact 256 of the first relay A 248 operated correctly. The IED 280 may return health indications for an output, trip circuit, and circuit breaker rather than a simple binary “1” or “0” indicating whether there is an open-circuit condition. The IED 280 may effectively indicate the health and operability of the first output contact 256 even when there are multiple tripping devices coupled together.

The data processing system 282 of the IED 280 may execute instructions from a tangible, non-transient, computer-readable medium to cause the data processing system 282 to send an indication to a relay (e.g., the first relay A 248) to activate (e.g., close) an output contact (e.g., the first output contact 256) of the relay (e.g., first relay A 248). The data processing system 282 may determine if a trip window is activated. The trip window may define the interval during which the relay (e.g., the first relay A 248) can expect to measure current (e.g., via the first current measuring component 264) through the closed contact and consequently, the interval during which a closed contact with no measured current constitutes a failure.

Furthermore, the data processing system 282 may receive an indication of a current (e.g., via the first current measuring component 264 coupled to the output 262 of the first output contact 256) through the output contact (e.g., the first output contact 256). The data processing system 282 may determine that the current through the output contact (e.g., the first output contact 256) exceeds the first current threshold based on the indication of the current through the output contact (e.g., the first output contact 256). The data processing system 282 may transmit a notification that the output contact (e.g., the first output contact 256) activated successfully based on the determination that the current through the output contact (e.g., the first output contact 256) exceeded the first current threshold.

In addition, the data processing system 282 may determine if the trip window is activated based on an indication received via a voltage sensor (e.g., the first voltage measuring component 258). The indication received via the voltage sensor (e.g., the first voltage measuring component 258) may include an indication that a voltage across the output contact (e.g., the first output contact 256) dropped below a threshold voltage value.

The data processing system 282 may send an indication to the relay (e.g., the first relay A 248) to activate (e.g., close) the output contact (e.g., the first output contact 256) of the relay (e.g., first relay A 248). Furthermore, the data processing system 282 may receive an indication of a voltage (e.g., via the first voltage measuring component 258 coupled to the input 260 of the first output contact 256 and the output 262 of the first output contact 256) across the output contact (e.g., the first output contact 256). The data processing system 282 may transmit a notification that the output contact (e.g., the first output contact 256) has not activated successfully based on determining that the voltage across the output contact (e.g., the first output contact 256) exceeded the voltage threshold.

Additionally, the data processing system 282 may send an indication to the relay (e.g., the first relay A 248) to activate (e.g., close) the output contact (e.g., the first output contact 256) of the relay (e.g., first relay A 248). The data processing system 282 may determine that the current through the output contact (e.g., the first output contact 256) does not exceed the first current threshold based on the indication of the current through the output contact (e.g., the first output contact 256). After the data processing system 282 determines that the trip window is still activated, the data processing system 282 may transmit a notification that the output contact (e.g., the first output contact 256) has not activated successfully based on the determination that the current through the output contact (e.g., the first output contact 256) is below the first current threshold.

The data processing system 282 may determine that the current through the output contact (e.g., the first output contact 256) exceeds the first current threshold for a duration of time that exceeds the trip window duration. If the data processing system 282 determines that the duration of the current through the output contact (e.g., the first output contact 256) exceeds the trip window duration, then the data processing system 282 may transmit a notification that a breaker is stuck.

Furthermore, the data processing system 282 may determine that the current though the output contact (e.g., the first output contact 256) exceeds a second current threshold. If the data processing system 282 determines that the current surpasses the second current threshold, then the data processing system 282 may transmit a notification that a short circuit occurred.

In another example, in a hybrid centralized distributed scheme, the first relay A 248 may be a first IED and the second relay B 250 may be a second IED. The voltage sensors (e.g., the first voltage measuring component 258 and the second voltage measuring component 268) and the current sensors (e.g., the first current measuring component 264 and the second current measuring component 274) may record information (e.g., measurement readings). Furthermore, the first IED of the first relay A 248 may measure voltage and current within the first relay A 248, and the second IED of the second relay B 250 may measure voltage and current within the second relay B 250. In the hybrid centralized distributed scheme, the first relay A 248 and the second relay B 250 may each include a data processing system 282 and may each perform the operations of the data processing system 282 as described above.

In some instances, the second IED of the second relay B 250 may communicate with the first IED of the first relay A 248 and send the voltage and current measurements of the second relay B 250 to the first IED of the first relay A 248. The first IED of the first relay A 248 may determine the operation of the first output contact 256 and the operation of the second output contact 266. It should be noted that the second IED may determine the operation of both output contact instead of the first IED. Furthermore, there may be other configurations able to perform the measurements and determine the outcome of a corresponding output contact.

In the illustrated embodiment, the second test switch 278 coupled to the second relay B 250 is open. If only the first output contact 256 of the first relay A 248 includes comprehensive monitoring logic and the second output contact 266 of the second relay B 250 does not include the comprehensive monitoring logic, then the second test switch 278 being open may go unnoticed. Alternatively, if only the second output contact 266 of the second relay B 250 includes the comprehensive monitoring logic and the first output contact 256 of the first relay A 248 does not include the comprehensive monitoring logic, an operator might assume there is a problem in the breaker due to the second test switch 278 being open. With both relays utilizing comprehensive measuring output contacts and integrated TCM logic, then an alarm from the second relay B 250 coupled with a lack of alarm from the first relay A 248 indicates there may be a problem with only the second relay B 250 portion of the circuit 246. It should be noted that while the illustrated embodiment shows two relays, the method described above may be utilized in a system with any number of relays (e.g., 3, 4).

The role of the trip circuit may be to transfer a relay trip decision to the breaker. In terms of energy transformation, the function of the trip coil may be to change electrical energy into magnetic energy, and subsequently, the plunger movement of the trip coil may transform the magnetic energy into mechanical energy. During the process of converting electrical energy into mechanical energy, the electromechanical characteristics of the trip coil and breaker mechanism may be captured in an electric current through the trip circuit. This electric current may capture a unique current and time profile or trip signature that may be very consistent for an individual breaker. This consistency indicates that deviations from an expected signature may be indicative of specific failures in the trip circuit and breaker mechanism.

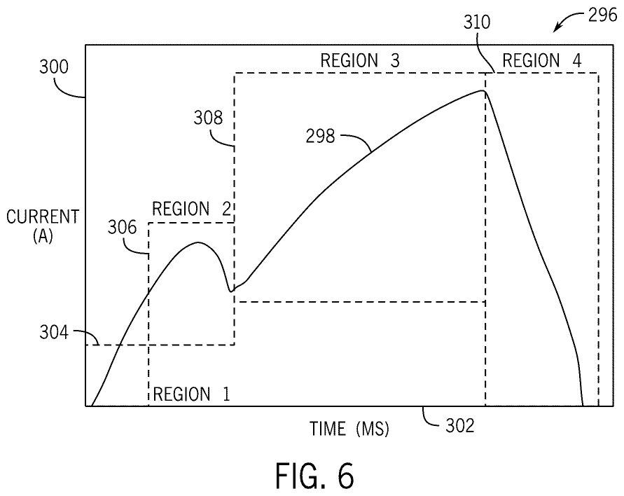

FIG. 6 is a graph illustrating a plot 296 of a current profile 298 for a trip coil. The TCM logic described above may provide a protection speed indication (e.g., a few milliseconds) of the trip circuit, trip coil mechanism, and breaker mechanism health utilizing the voltage measurements, current measurements, and corresponding characteristic waveforms. While different breakers, trip coils, and installations may have different trip current signatures, many may share a similar characteristic current waveform.

The current profile 298 in the illustrated embodiment may depict a typical trip current characteristic waveform for a properly operating breaker and trip coil. The current profile 298 follows a vertical axis 300 (e.g., y-axis) measuring current in amps and a horizontal axis 302 (e.g., x-axis) measuring time in milliseconds.

Region one 304 may be categorized by the trip contact closure and current rise. A first rise in the current profile 298 may correspond to the trip coil solenoid energizing. For example, the relay closes the trip contact, and the current starts flowing through the circuit. The current rise may be limited by the circuit and electrical characteristics of the coil.

Region two 306 may be characterized by plunger movements. Once the current in the trip coil reaches a value high enough to cause a large electromotive force (EMF) that overcomes the reset spring, the plunger may start to accelerate. The metallic plunger may generate a back EMF, due to Lenz's law of electromagnetic induction. For example, the current starts to level out and may decrease as the solenoid plunger moves, producing back emf which may reduce the current, until it hits a latch. As the plunger contacts the latch and the latch is released there may be local inflection points.

Region three 308 may be categorized by post-plunger movements. After, the plunger hits the trip latch on the breaker, it may stop moving because it has reached its maximum travel distance. This may result in a reduction of the back EMF on the trip coil, allowing the current to start rising again based on the L/R characteristics of the coil. The current may increase until it reaches its maximum value, determined by the voltage applied to the TC and the resistance of the coil. For example, after the plunger hits the latch and reaches the extent of its travel, the current may continue to increase until it reaches the DC steady state. While the current is reaching DC steady state, the breaker operator starts opening the primary breaker contacts.

Region four 310 may be categorized by breaker contact operation and current decay. Once the trip latch actuates, the stored energy in the breaker may cause the mechanical assembly to operate, tripping open the power contacts of the circuit breaker and leading to a change of state of the auxiliary breaker contacts. One of the 52a auxiliary contacts may open, breaking the continuity of the trip circuit and allowing the coil current to decay from its maximum value to zero, again as a function of the L/R characteristics of the coil. For example, once the breaker primary contacts open, the mechanically linked auxiliary ‘52a’ contact may also open, breaking the trip current and allowing it to decay back to 0.

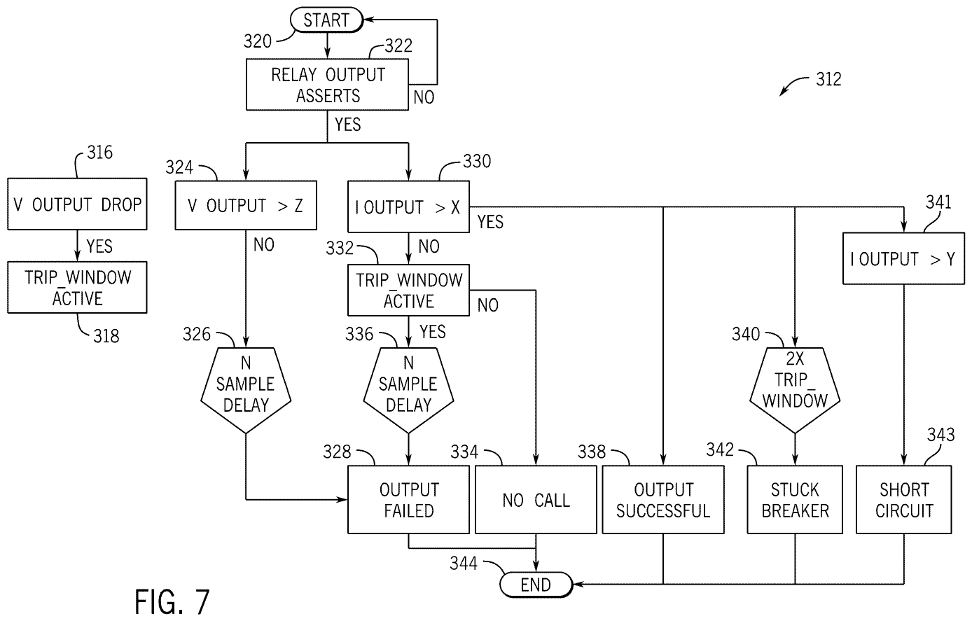

FIG. 7 is a flowchart of an example method 312 for enhanced trip circuit monitoring, according to embodiments of the present disclosure. The method 312 may be performed by the IED 280 or components and/or algorithms thereof. The method 312 includes various steps represented by blocks. Although the flowchart illustrates the steps in a certain sequence, it should be understood that the steps may be performed in any suitable order and certain steps may be carried out simultaneously, where appropriate. Further, certain steps or portions of the method 312 may be performed by separate systems or devices. It should be noted that the method 312 may be performed during normal (e.g., runtime) operation of the IED 280.

To discriminate between output contact failures and other scenarios in which the output contact is closed and no current is measured, the algorithm may use the trip window, which may begin upon the detection of a voltage drop (e.g., determined by the first voltage measuring component 258) across the first output contact 256 of FIG. 5. When the first output contact 256 closes, the measured voltage across the first output contact 256 may drop to zero. The trip window may define the interval during which the relay (e.g., the first relay A 248) can expect to measure current (e.g., via the first current measuring component 264) through the closed contact and consequently, the interval during which a closed contact with no measured current constitutes a failure. Additionally, the trip window defines the expected duration of the measured trip current; if current is measured for significantly longer than the trip window duration, this may indicate a successful contact operation but an issue in the circuit breaker (e.g. a stuck breaker).

The DC voltage may be measured across the output contact (e.g., the first output contact 256) that energizes the trip or close coil as described above. This voltage may drop to zero for a few different reasons including when the monitored output (e.g., via the first voltage measuring component 258) closes and/or when a parallel output (e.g., via the second voltage measuring component 268) closes, as shown in FIG. 5. The method 312 may utilize the algorithm to flag successful, failed, or no call output contact operations. In addition, the integrated voltage measurement may provide a way for the IED to detect external parallel trip assertion and may be used to start a trip window timer. This may allow the relay to determine if the current should have been detected and prevents false output failure declarations.

There may be two scenarios to declare an output failure. In a first scenario, an output contact control equation asserts while the trip window is active, but no current (e.g., via the first current measuring component 264) is measured through the output contact (e.g., the first output contact 256). In a second scenario, the output contact control equation asserts, and the overvoltage detection remains asserted. If the conditions for either scenario are true for longer than a duration of time it takes for a metallic contact to close (e.g., 8 milliseconds), a failed operation may be declared and sealed in until the output contact control equation deasserts, at which point it is reset for the next operation.

A no call may be for a race condition when two output contacts (e.g., the first output contact 256 and the second output contact 266) are tripping the same coil (e.g., the TC 254). For example, the first relay A trips and the trip coil operates. A short time later (e.g. longer than the trip window), the second relay B operates, but the trip coil has already been energized and completed its cycle. In this scenario, the first current measuring component 264 will measure current but the second current measuring component 274 will not. However, because the trip window is no longer active, the lack of measured current by the current measuring component 274 represents a no call condition, instead of an output failure.

In a trip circuit with multiple contacts in parallel, it is possible that a contact may be commanded to close after a breaker trip cycle is complete (e.g., after the trip window asserts and then times out). In that case, it may not be possible to determine whether the output contact (e.g., the first output contact 256) operated successfully or failed to operate, and the algorithm may return a no-call result. If the output control equation asserts and no current is measured but the trip window is not armed, the no-call output may be asserted after a short time delay. The no-call output may be blocked by the success or fail outputs. Therefore, the no-call logic may prevent false alarms in tripping schemes in which multiple devices can trip a coil.

When operating current flow through the output contact (e.g., the first output contact 256) is measured for a duration longer than the trip window duration, it may indicate a slow breaker. When current higher than the expected coil operating current is detected, a high-current alarm output may be asserted after a short, qualifying time delay, indicating a potential short in the trip circuit.

In process block 316, the method 312 may determine if an output voltage drops (e.g., via the first voltage measuring component 258) below a low-set threshold after being above a high-set threshold. The voltage drop may indicate a contact closure. Furthermore, the voltage drop may occur because of other events outside a relay receiving an indication to close an output contact. In addition, the process block 316 may run continuously or iteratively.

If the method 312 may determine that the voltage drops (e.g., via the first voltage measuring component 258) below the low-set threshold after being above the high-set threshold, then the method 312 may continue to process block 318 where a trip window may be activated. The trip window may be the time when a closed relay output contact would expect to see current and the trip window duration may be a learned value, or a set time defined by the user. The trip window may activate for reasons outside the relay receiving the indication to close the output contact.

The method 312 may continue to run at process block 320, which may be triggered by the start of a relay processing interval. The method 312 may continue to process block 322.

In process block 322, the method 312 may determine if the relay output is asserted. The relay output is asserted when the output contact is called upon to close. This may happen before or after the trip window activates and is processed separately. If the relay output is not asserted then the method 312 may return to process block 320.

If the method 312 determines that the relay output is asserted, then the method 312 may continue to process block 324. In process block 324, the method 312 may determine if voltage across the relay output is above a threshold.

If the voltage across the output is not above a threshold, then the method 312 may continue to process block 326. In process block 326, the method 312 may wait for a pre-determined number of sample delays (e.g., 3, 5, 10, etc.) for the voltage to drop. Each sample delay may last for about a millisecond.

After waiting for the pre-determined number of sample delays, the method 312 may continue to process block 328. In process block 328, the method 312 may determine a failed output due to the presence of voltage across the output (e.g., via the first voltage measuring component 258) after the method 312 determined the relay output was asserted. The method 312 may transmit a notification to the user that the output contact has not activated successfully based on determining that the voltage across the output contact is above the voltage threshold.

In addition, if the method 312 determines that the relay output is asserted, then the method 312 may continue to process block 330. In process block 330, the method 312 may determine if there is current through the output contact (e.g., via the first current measuring component 264) and may determine if the current through the output contact exceeds the first current threshold.

If the current is below the first current threshold, then the method 312 may continue to process block 332. In process block 332, the method 312 may determine if the trip window is active.

If the trip window is not active, then the method 312 may continue to process block 334. In process block 334, the method 312 may determine a no call due to no voltage change and no current change after the method 312 determined the relay output was asserted. The no call may occur when a relay attempts a trip outside of the trip window where the breaker has already been tripped by a different device and is open. Additionally, the no call may occur with an open circuit (e.g., test switch, loose/corroded wire). The voltage may have been at zero for a long time and the current will not rise if the output is closed.

Alternatively, if the trip window is active, then the method 312 may continue to process block 336. In process block 336, the method 312 may wait for a pre-determined number of sample delays (e.g., 3, 5, 10, etc.) for the current to go above the first threshold. Each sample delay may last for about a millisecond.

After waiting the pre-determined number of sample delays, the method 312 may continue to process block 328. In process block 328, the method 312 may determine the failed output due to no current rising (e.g., via the first current measuring component 264) after the method 312 determined the relay output was asserted and the trip window was active. The method 312 may transmit a notification to the user that the output contact has not activated successfully based on determining that the current through the output contact is below the first current threshold.

If the current is above the first current threshold, then the method 312 may continue to process block 338. In process block 338, the method 312 may determine a successful output due to the current through the output contact being above the first threshold. The method 312 may transmit a notification to the user that the output contact has activated successfully based on determining that the current through the output contact is above the first current threshold.

In addition, if the current is above the first current threshold, then the method 312 may continue to process block 340. In process block 340, the method 312 may wait for a duration of two trip window delays.

After waiting, the method 312 may continue to process block 342. In process block 342, the method 312 may determine a stuck breaker. This may look similar to FIG. 6 except for the last rise in the current shown in region 3 308 may continue much longer. When the contact is closed, the voltage may drop from nominal to zero and the current may rise to a relative maximum and may continue past the trip window duration. The method 312 may transmit a notification to the user that a breaker is stuck based on determining that the duration of the current through the output contact exceeds the trip window.

Furthermore, if the current is above the first current threshold, then the method 312 may continue to process block 341. In process block 341, the method 312 may determine if there is current through the output contact (e.g., via the first current measuring component 264) and may determine if the current through the output contact exceeds the second current threshold.

If the current is above the second current threshold, then the method 312 may continue to process block 343. In process block 343, the method 312 may determine if there is a short circuit. The short circuit may occur for a failed coil or improper wiring. When the relay commands the output to close, voltage may drop from nominal to zero and current may sharply shoot up to a maximum without exhibiting the characteristics of FIG. 6. The current may stay at a max value until some component in the trip circuit fails or a protective breaker or fuse interrupts the current. Typically, a short circuit may draw a much larger amount of current than a stuck breaker.

After determining an outcome such as the failed output, the no call, the successful output, and/or the stuck breaker and/or the short circuit, the method 312 may continue to process block 344. At process block 344, the method may end, signaled by the end of the processing interval, and any appropriate corrective action may be taken. For example, notification of a failed output or a short circuit may be used to initiate corrective maintenance. Conversely, notification of a successful output operation may be logged for compliance reporting. Additional automatic operations such as re-tripping or issuing breaker failure trip (BFT) signals may be taken upon notification of a failed output or a stuck breaker. After the end of the processing interval, the method 312 may continue to process block 320 at the start of the next interval.

In other examples, process block 326 and process block 336 may include counters that increase during each processing interval when the method 312 passes through. Once the counters surpass an indicated number, the determined outcome may be called.

If a re-trip is issued on a secondary trip coil, the same algorithm may be used, but instead of issuing a re-trip, the relay may directly issue a BFT. For example, if a trip is issued to the first trip coil and the output contact is failed, then the relay may issue a re-trip to the second trip coil. If the second output is also failed, the relay may issue a BFT with no additional delay.

Additionally, or alternatively, the algorithm may also be implemented using external current and voltage sensing. The current sensor may be in series with the output contact of the local IED, prior to connecting to parallel trip paths on the trip circuit. The window of opportunity timer may also be initiated with the deassertion of a binary input that is wired in parallel to the trip output.

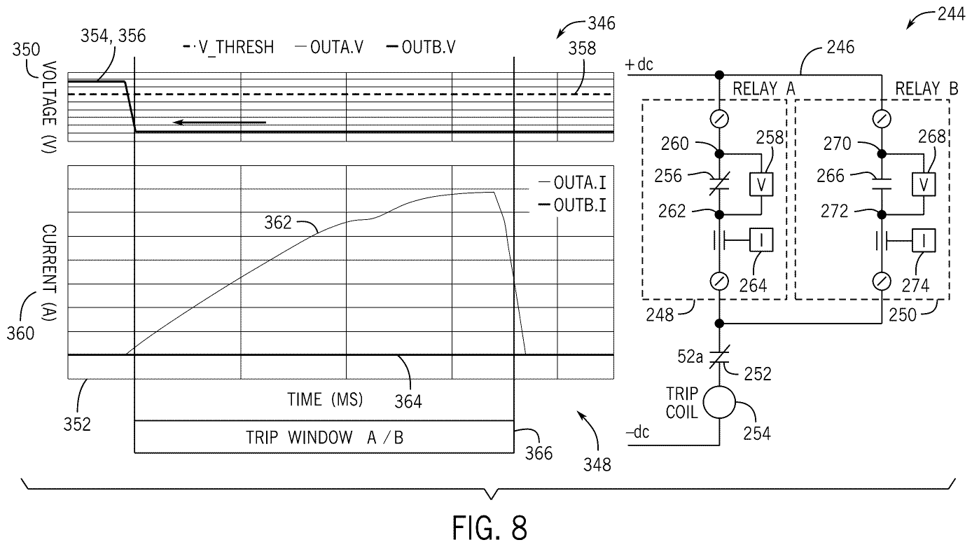

Some possible examples of the outcomes discussed above will be depicted in FIGS. 8-12 using the trip circuit shown in FIG. 5. The system includes two relays, the first relay A and the second relay B, wired in parallel to the 52a contact and the trip coil. The first relay A may include the first output contact, and the second relay B may include the second output contact.

FIGS. 8-12 highlight various outcomes of the example method 312 of FIG. 7 for enhanced trip circuit monitoring. FIGS. 8-12 include the schematic diagram of FIG. 5 depicting the trip circuit system 244 with the circuit 246 and the relay contact monitoring scheme. Additionally, FIGS. 8-12 include two graphs, a voltage plot 346 of voltage profiles for the first relay A 248 and the second relay B 250 and a current plot 348 of current profiles for the first relay A 248 and the second relay B 250. While different breakers, trip coils, and installations may have different trip current signatures, many may share a similar characteristic current waveform.

The voltage plot 346 follows a vertical axis 350 (e.g., y-axis) measuring voltage in volts and a horizontal axis 352 (e.g., x-axis) measuring time in milliseconds. The voltage plot 346 in the illustrated embodiment may depict a voltage profile 354 of the first relay A 248, a voltage profile 356 of the second relay B 250, and a voltage threshold 358.

The current plot 348 follows a vertical axis 360 (e.g., y-axis) measuring current in amps and a horizontal axis 352 (e.g., x-axis) measuring time in milliseconds. The current plot 348 in the illustrated embodiment may depict a current profile 362 of the first relay A 248 and a current profile 364 of the second relay B 250.

With the foregoing in mind, FIG. 8 includes the voltage plot 346 and the current plot 348 of a trip window 366 of the first relay A 248 and the second relay B 250 and the schematic diagram of the trip circuit system 244 of FIG. 5. In the illustrated embodiment, the trip window 366 begins when the voltage of both the first relay A 248 and the second relay B 250 drops to zero as illustrated by the voltage profiles 354, 356 on the voltage plot 356. The trip window 366 ends when the current profile 362 from the first relay A 248 begins to fall, but it should be noted that the trip window duration may be calculated or manually programmed.

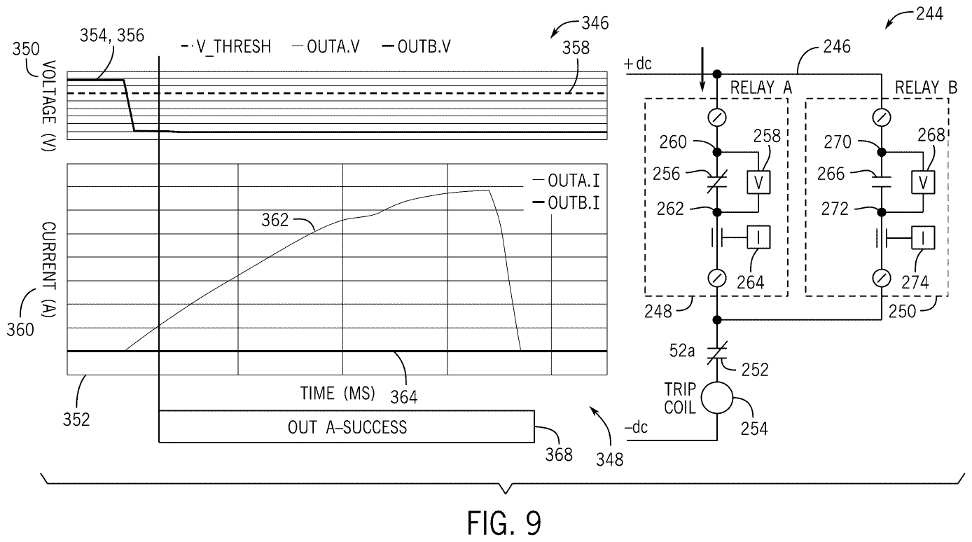

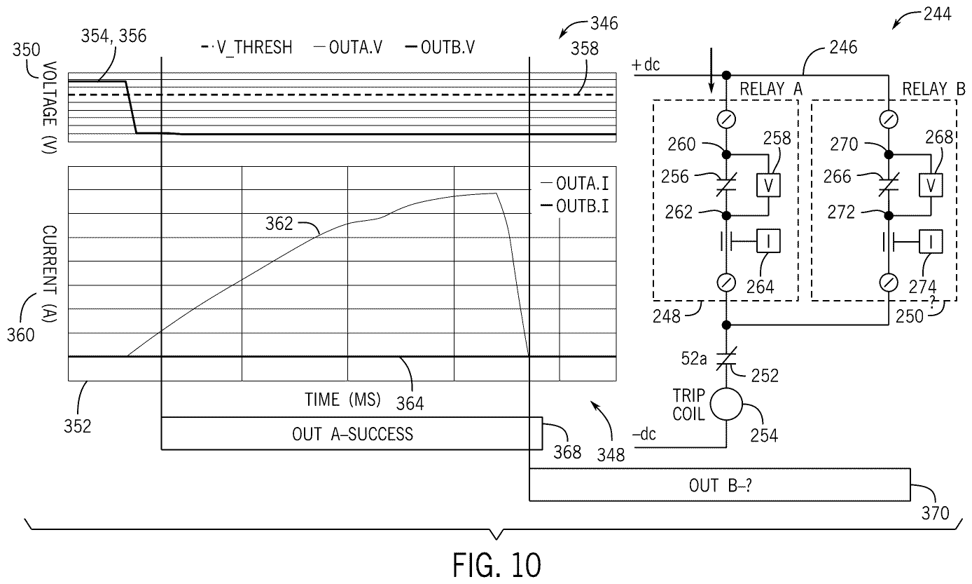

FIG. 9 includes the voltage plot 346 and the current plot 348 of a successful output 368 of the first relay A 248 and the schematic diagram of the trip circuit system 244 of FIG. 5. The algorithm may determine the successful output 368 after the current (e.g., the current profile 362) exceeds the first current threshold.

FIG. 10 includes the voltage plot 346 and the current plot 348 of the successful output 368 of the first relay A 248 and an unknown output 370 of the second relay B 250 and the schematic diagram of the trip circuit system 244 of FIG. 5. In the illustrated embodiment, the unknown output 370 may appear to indicate a failure due to no current in the current profile 364 of the second relay B 250 as illustrated in the current plot 348. However, a failure may not be declared unless the indication occurred within the trip window 366 (i.e. unless an indication to close the second output contact 266 of the second relay B 250 occurred within the trip window).

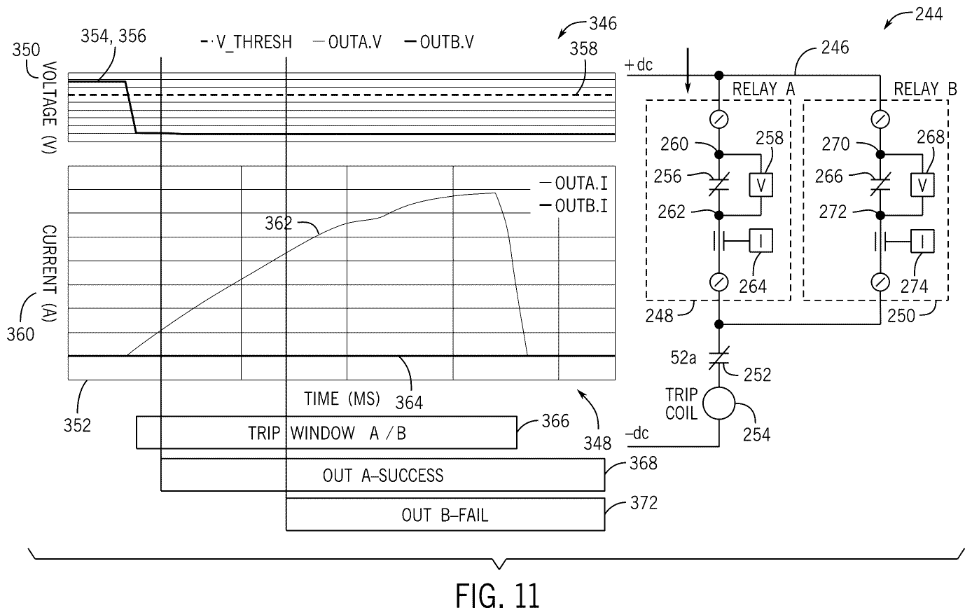

FIG. 11 includes the voltage plot 346 and the current plot 348 of the trip window 366 of the first relay A 248 and the second relay B 250, the successful output 368 of the first relay A 248, and a failed output 372 of the second relay B 250 and the schematic diagram of the trip circuit system 244 of FIG. 5. In the illustrated embodiment, the indication for the failed output 372 occurred within the trip window 366, therefore a failure may be declared.

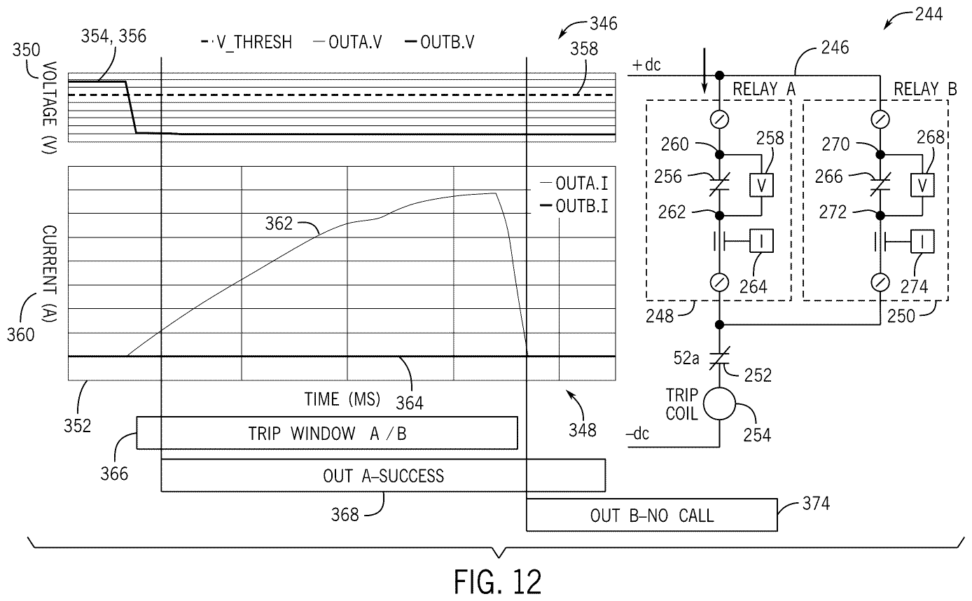

FIG. 12 includes the voltage plot 346 and the current plot 348 of the trip window 366 of the first relay A 248 and the second relay B 250, the successful output 368 of the first relay A 248, and a no call 374 of the second relay B 250 and the schematic diagram of the trip circuit system 244 of FIG. 5. In the illustrated embodiment, the operation of the output contact occurred outside of the trip window 366, therefore no call 374 is used to prevent alerting when a repair is not called for.

While specific embodiments and applications of the disclosure have been illustrated and described, it is to be noted that the disclosure is not limited to the precise configurations and devices disclosed herein. For example, the systems and methods described herein may be applied to an industrial electric power delivery system or an electric power delivery system implemented in a boat or oil platform that may or may not include long-distance transmission of high-voltage power. Accordingly, many changes may be made to the details of the above-described embodiments without departing from the underlying principles of this disclosure. The scope of the present disclosure should, therefore, be determined only by the following claims.

Indeed, the embodiments set forth in the present disclosure may be susceptible to various modifications and alternative forms, specific embodiments have been shown by way of example in the drawings and have been described in detail herein. However, it may be noted that the disclosure is not intended to be limited to the particular forms disclosed. The disclosure is to cover all modifications, equivalents, and alternatives falling within the spirit and scope of the disclosure as defined by the following appended claims. In addition, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). For any claims containing elements designated in any other manner, however, it is intended that such elements are not to be interpreted under 35 U.S.C. 112(f).

What is claimed is:

1. A protection system comprising:
a first relay, comprising:
a first output contact;
a first voltage sensor coupled to a first input of the first output contact and a first output of the first output contact; and
a first current sensor coupled to the first output of the first output contact; and
processing circuitry configured to determine that the first output contact is operational based on a first indication received from the first voltage sensor, a second indication received from the first current sensor, or both.

2. The protection system of claim 1, wherein the first relay is configured to receive a third indication from the processing circuitry to close the first output contact.

3. The protection system of claim 1, wherein the processing circuitry is configured to determine a change in a voltage based on the first indication.

4. The protection system of claim 3, wherein determining the change in the voltage comprises determining that the voltage has dropped below a voltage threshold.

5. The protection system of claim 1 wherein the processing circuitry is configured to determine a change in a current based on the second indication.

6. The protection system of claim 5, wherein determining the change in the current comprises determining an increase in the current above one or more current thresholds.

7. The protection system of claim 2, comprising a second relay, the second relay comprising:
a second output contact;
a second voltage sensor coupled to a second input of the second output contact and a second output of the second output contact; and
a second current sensor coupled to the second output of the second output contact.

8. The protection system of claim 7, wherein the processing circuitry is configured to determine that the first output contact is not operational based on a fourth indication received from the first voltage sensor, a fifth indication received from the first current sensor, or both.

9. The protection system of claim 8, wherein the processing circuitry is configured to determine a change in voltage based on the fourth indication to the processing circuitry based on the first relay receiving the third indication to close the first output contact and determining no change in voltage after receiving the third indication from the processing circuitry to close the first output contact.

10. The protection system of claim 8, wherein the second voltage sensor is configured to measure a change in voltage and send the fourth indication to the processing circuitry based on the first relay receiving the third indication to close the first output contact and determining no change in voltage after receiving the third indication from the processing circuitry to close the first output contact.

11. A tangible, non-transient, computer-readable medium comprising instructions that, when executed by a data processing system, cause the data processing system to:
send, to a first relay, a first indication that an output contact of the first relay is to activate;
determine that a trip window has activated;
receive, via a current sensor coupled to an output of the output contact, a second indication of a current through the output contact;
determine, based on the second indication, that the current through the output contact exceeds a current threshold; and
transmit a notification that that the output contact has activated successfully based on determining that the current through output contact is above the current threshold.

12. The tangible, non-transient, computer-readable medium of claim 11, wherein the data processing system determines that the trip window has activated based on a third indication received from a voltage sensor.

13. The tangible, non-transient, computer-readable medium of claim 12, wherein the third indication comprises an indication that a voltage across the output contact dropped below a threshold voltage value.

14. The tangible, non-transient, computer-readable medium of claim 11, wherein the instructions cause the data processing system to:
send, to the first relay, a third indication that the output contact of the first relay is to activate; and
receive, via a voltage sensor coupled to an input of the output contact and the output of the output contact, a fourth indication of a voltage across the output contact.

15. The tangible, non-transient, computer-readable medium of claim 14, wherein the instructions cause the data processing system to transmit a notification that that the output contact has not activated successfully based on determining that the voltage across the output contact is above a voltage threshold.

16. The tangible, non-transient, computer-readable medium of claim 11, wherein the instructions cause the data processing system to:
send, to the first relay, a fifth indication that the output contact of the first relay is to activate;
determine, based on the second indication, that the current through the output contact does not exceed the current threshold;
determine that the trip window is still activated; and
transmit a notification that that the output contact has not activated successfully based on determining that the current through output contact is below the current threshold.

17. The tangible, non-transient, computer-readable medium of claim 11, wherein the instructions cause the data processing system to:
determine, based on a sixth indication, that the current through the output contact exceeds the current threshold for a duration of time that exceeds the trip window; and
transmit a notification that that a breaker is stuck based on determining that the duration of the current through the output contact exceeds the trip window.

18. The tangible, non-transient, computer-readable medium of claim 17, wherein the instructions cause the data processing system to:
determine, based on a seventh indication, that the current through the output contact exceeds an additional current threshold greater than the current threshold for a duration of time that exceeds the trip window; and
transmit a notification that a short circuit is present based on determining that the current through the output contact exceeds the additional current threshold.

19. A relay, comprising:
an output contact;
a voltage sensor coupled to an input of the output contact and an output of the output contact within a housing of the relay; and
a current sensor coupled to the output of the output contact within the housing of the relay.

20. The relay of claim 19, wherein the relay comprises processing circuitry configured to determine that the output contact is operational based on a first indication received from the voltage sensor, a second indication received from the current sensor, or both.
